(19) United States
(12) Patent Application Publication
(10) Pub. No.: US 2026/0277227 A1
(43) Pub. Date: Sep. 17, 2026

(54) RISK AWARE MODEL PREDICTIVE PATH INTEGRAL CONTROL FOR STOCHASTIC HYBRID SYSTEMS

(71) Applicants: Toyota Motor Engineering & Manufacturing North America, Inc., Plano, TX (US); The Regents Of The University Of Michigan, Ann Arbor, MI (US)

(72) Inventors: Hardik Parwana, Ann Arbor, MI (US); Mitchell Black, Boston, MA (US); Georgios Fainekos, Novi, MI (US); Bardh Hoxha, Canton, MI (US); Hideki Okamoto, Ann Arbor, MI (US); Danil V. Prokhorov, Canton, MI (US); Dimitra Panagou, Ann Arbor, MI (US)

(73) Assignees: Toyota Motor Engineering & Manufacturing North America, Inc., Plano, TX (US); The Regents Of The University Of Michigan, Ann Arbor, MI (US); Toyota Jidosha Kabushiki Kaisha, Toyota-shi Aichi-ken (JP)

(21) Appl. No.: 19/080,119

(22) Filed: Mar. 14, 2025

(51) Int. Cl. G05D 1/633; G05D 1/644; G05D 1/86

(52) U.S. Cl. CPC G05D 1/633; G05D 1/644; G05D 1/86

(57) ABSTRACT

A computer-implemented method of path planning for a mobile robot in a dynamic environment is provided, the method includes modeling awareness of an agent for the path planning. An Expansion-Compression (EC) Unscented Transform (UT) Model Predictive Path Integral (MPPI) controller comprising an ECUT algorithm and MPPI algorithm is used for the path planning by sampling possible trajectories of the mobile robot around a nominal trajectory and assigning weights to the trajectories based on a cost incurred. A final trajectory of the mobile robot is determined from a weighted summation of all the sampled trajectories.

### TECHNICAL FIELD

The present specification generally relates to path planning for stochastic hybrid systems.

### BACKGROUND

Hybrid dynamical systems in which the dynamics function changes in response to an event, appear in several robotic applications. Examples include walking legged robots, contact-rich quadrotor navigation, and mobile robot navigation on different terrains. In practice, due to disturbances or a priori unknown dynamics of the robot or the environment, these systems are often modeled as stochastic hybrid systems. While there is extensive research on path planning and control for hybrid dynamical systems, what is needed are model predictive approaches to address these challenges.

### SUMMARY

In one embodiment, a computer-implemented method of path planning for a mobile robot in a dynamic environment is provided, the method includes modeling awareness of an agent for the path planning. An Expansion-Compression (EC) Unscented Transform (UT) Model Predictive Path Integral (MPPI) controller comprising an ECUT algorithm and MPPI algorithm is used for the path planning by sampling possible trajectories of the mobile robot around a nominal trajectory and assigning weights to the trajectories based on a cost incurred. A final trajectory of the mobile robot is determined from a weighted summation of all the sampled trajectories.

In another embodiment, a computer-implemented method of path planning for a mobile robot in a dynamic environment is provided. The method includes using an Expansion-Compression (EC) Unscented Transform (UT) Model Predictive Path Integral (MPPI) controller comprising an ECUT algorithm and MPPI algorithm for the path planning. A final trajectory of the mobile robot is determined from a weighted summation of sampled trajectories.

In another embodiment, a system configured to plan a path for a mobile robot in a dynamic environment includes a computer comprising logic saved in memory that is configured to model awareness of an agent for the path planning, use an Expansion-Compression (EC) Unscented Transform (UT) Model Predictive Path Integral (MPPI) controller comprising an ECUT algorithm and MPPI algorithm for the path planning by sampling possible trajectories of the mobile robot around a nominal trajectory and assign weights to the trajectories based on a cost incurred, and determine a final trajectory of the mobile robot from a weighted summation of all the sampled trajectories.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts an optimization problem, according to one or more embodiments shown and described herein;

FIG. 2 depicts a problem solved by a MPPI algorithm, according to one or more embodiments shown and described herein;

FIG. 3 depicts the sample (or empirical) mean and covariance of x_{p,t}, according to one or more embodiments shown and described herein;

FIG. 4 depicts an Expansion-Compression UT algorithm, according to one or more embodiments shown and described herein;

FIG. 5 depicts a design for MPPI optimization, according to one or more embodiments shown and described herein;

FIG. 6 schematically depicts a timestamped robot's trajectory using the framework described herein, according to one or more embodiments shown and described herein;

FIG. 7 depicts an ECUT-MPPI controller for use with the framework described herein, according to one or more embodiments shown and described herein;

FIG. 8A depicts a simulation result for the method described herein showing the robot performs collision avoidance with humans and obstacles, according to one or more embodiments shown and described herein;

FIG. 8B depicts cost and stability cost accumulates with time in the simulation of FIG. 8A, according to one or more embodiments shown and described herein;

FIG. 8C depicts the robot's minimum distance to any human in the simulation of FIG. 8A, according to one or more embodiments shown and described herein;

FIG. 8D depicts the robot's minimum distance to any obstacle in the simulation of FIG. 8A, according to one or more embodiments shown and described herein;

FIG. 9A depicts accumulated cost for simulation results for RA-MPPI inspired method described in Multi-agent Navigation section herein, according to one or more embodiments shown and described herein;

FIG. 9B depicts minimum distance to humans for the simulation results for RA-MPPI inspired method of FIG. 9A, according to one or more embodiments shown and described herein;

FIG. 9C depicts minimum distance to obstacles for the simulation results for RA-MPPI inspired method of FIG. 9A;

FIG. 10A depicts simulation results for RA-MPPI with 100 samples per human;

FIG. 10B depicts simulation results for RA-MPPI with 100 samples per human; and

FIG. 10C depicts simulation results for RA-MPPI with 100 samples per human.

### DETAILED DESCRIPTION

The present disclosure is directed to path planning for stochastic hybrid systems, which can present a unique challenge of predicting distributions of future states subject to a state-dependent dynamics switching function. A variant of Model Predictive Path Integral Control (MPPI) is described herein to plan kinodynamic paths for such systems. As Monte Carlo may be inaccurate when few samples are chosen to predict future states under state-dependent disturbances, Unscented Transform-based methods may be employed to capture stochasticity in the states as well as the state-dependent switching surfaces. A motion planning application is focused on the navigation of a mobile robot in the presence of dynamically moving agents whose responses are based on sensor-constrained attention zones. The framework is evaluated on a simulated mobile robot and show faster convergence to a goal without collisions when the robot exploits the hybrid human dynamics versus when it does not.

A need for studying such systems arises from navigation challenges, and particularly two interrelated, but often independently addressed, challenges. First, the motion of agents, whether human or non-human, may be challenging due to noisy observations of past states and the often unpredictable behavior of these agents (e.g., sudden changes in direction). Planners should account for this inherent uncertainty, which may be captured by modeling agent motion as a stochastic hybrid system. Second, agents may abruptly alter their behavior upon perceiving new entities in their environment, including robots, obstacles, or other agents. Agents' dynamic modes may be modeled as hybrid dynamical systems, where each mode represents varying levels of cooperation or responsiveness to a robot. Mode switching may be triggered, for example, when the robot enters an agent's attention zone, such as a human's field of view or an aquatic or aerial agent's sensory range.

The integration of estimators into path planning systems can be important for navigating environments that involve diverse agents. In this disclosure, modeling cooperative behaviors where agent interactions are influenced by sensory zones is a focus, such as a field of view or sensory range. These factors play a role in enhancing situational awareness and guiding responses to dynamic environmental changes.

Since exact analytical expressions for propagating probability distributions through nonlinear functions are generally not available, several approximate methods have been developed to solve stochastic model predictive control (MPC). These methods include Monte Carlo simulations, successive Gaussian approximation, and the Unscented Transform. In the domain of hybrid systems, MPC problems are typically formulated as mixed-integer optimizations, which can become computationally prohibitive, particularly when the system dynamics are nonlinear.

Since solving the hybrid MPC exactly may not be feasible for real-time implementation, a Model Predictive Path Integral (MPPI) Control is adopted, a sampling-based, gradient-free method for solving unconstrained MPC problems in real-time. MPPI converts hard constraints into soft constraints by incorporating them into the objective function. Variants of MPPI may be used to address uncertainty in the initial state and disturbances in system dynamics. Applying MPPI to systems with state-dependent disturbances remains a challenge due to the lack of analytical methods for propagating future states under such disturbances. Advances in uncertainty propagation techniques for stochastic MPC are leveraged herein within the MPPI framework.

A particle-based uncertainty propagation scheme is proposed based on Unscented Transform in MPPI. First, by utilizing weighted particles, the stochasticity of states can be mapped to the stochasticity of mode switching, moving beyond deterministic switching based only on predicted state means. Second, MPPI can be extended to systems with arbitrary state-dependent disturbances. Both of these contributions enable us to define a risk-aware framework for path planning with respect to static and dynamic obstacles for a hybrid dynamical system. Experimental results demonstrate improved cost and safety performance by accounting for the hybrid nature of non-ego agent dynamics, compared to planning approaches that neglect cooperative behaviors or assume constant velocity models.

### Notation and Problem Formation

The set of real numbers is denoted as [symbol] . For x∈ [symbol] , y∈ [symbol] , |x| denotes the absolute value of x and ∥y∥ denotes the L₂ norm of y. The time derivative of x is denoted by \dot{x} and [symbol] denoted the gradient of a differentiable function F: [symbol] with respect to x∈ [symbol] .

Consider a robot with state xᵣ∈ [symbol] , control input uᵣ∈ [symbol] , and dynamics

$${x}_{r , t + 1} = fr ( {x}_{r , t} , {u}_{r , t} ) .$$

Each agent p is modeled as a stochastic hybrid (i.e., multimodal) dynamical system with continuous state xₚ∈ [symbol] and N operating modes qⱼ, for j∈{1, 2, . . . , [symbol] }. Each mode corresponds to different agent dynamics. For example, a robot may exhibit different behavior toward another agent when it enters its limited sensing region.

When the agent p is in mode q, then their motion is governed by stochastic dynamics D_{qj}: [symbol] × [symbol] → [symbol] , which depend both on the state of the person and the robot, that is,

$${x}_{p , t + 1} ∼ {D}_{qj} ( {x}_{p , t} , {x}_{r , t} ) .$$

A mode qⱼ is active in a region

$${A}_{j} = \{ ( {x}_{p} , {x}_{r} ) ∈ {ℝ}^{{n}_{p}} \times {ℝ}^{{n}_{r}} \vert {∧}_{k ∈ K} {g}_{j , k} ( {x}_{p} , {x}_{r} ) \leq 0 ,$$

where g_{j,k}: [symbol] × [symbol] → [symbol] are called activation functions for mode qⱼ. Assume that regions {Aⱼ}j≤N is form a partition of the space [symbol] × [symbol] .

Remark 1. To simplify, a hybrid dynamical model is introduced where the activation functions partition the agent-robot state space. However, the motion planning framework in this disclosure is more general and can handle general hybrid dynamical systems, see S. Mitra, Verifying Cyber-Physical Systems: A Path to Safe Autonomy. The MIT Press, 2021, which is incorporated herein by reference.

Multiple dynamic agents are allowed for in the described framework. When necessary, the subscript i, e.g., x_{p,t} D_{i,qj}, etc, is used to highlight the fact that multiple agents are present-potentially under different stochastic dynamics.

Example 1 (Simple motion model with attention radius). Consider the following attention regions corresponding to two operating modes q₁ (non-attentive) and 92 (attentive) of an external agent with corresponding regions

$${A}_{1} = \{ ( {x}_{p} , {x}_{r} ) \vert ‖ {x}_{p} - {x}_{r} ‖ \geq {d}_{s} \}$$

$${A}_{2} = \{ ( {x}_{p} , {x}_{r} ) \vert ‖ {x}_{p} - {x}_{r} ‖ \leq {d}_{s} \}$$

where ds is the sensing area of the agent. The stochastic dynamics in each mode are:

$${D}_{{q}_{1}} ( {x}_{p , t} , {x}_{r , t} ) = {x}_{p , t} + {u}_{g} ( {x}_{p , t} ) + {w}_{1 , t} ( {x}_{p , t} )$$

$${D}_{{q}_{2}} ( {x}_{p , t} , {x}_{r , t} ) = {x}_{p , t} + {u}_{g} ( {x}_{p , t} ) + {u}_{a} ( {x}_{p , t} , {x}_{r , t} ) + {w}_{2 , t} ( {x}_{p , t} )$$

where x_{p,t} and x_{r,t} are the positions of the agent and the robot, respectively, at time t, u_{g} models the agents' attraction toward their goal, uₐ models the agent's avoidance of the ego-robot, and w_{j,t} are appropriate noise terms that may depend on the state of the agent in general.

In general, the agents dynamics can also be written as

$${x}_{p , t + 1} ∼ {{\sum }_{j = 1}}^{N} {δ}_{j} {D}_{qj} ( {x}_{p , t} , {x}_{r , t} )$$

where δⱼ are binary variables and δⱼ=1 if mode qⱼ is active,

$${δ}_{j} = \{ \begin{matrix}1 & if ( {x}_{p , t} , {x}_{r , t} ) ∈ {A}_{j} \\ 0 & otherwise\end{matrix}$$

### Safety Constraints

An objective of the disclosure is to navigate a mobile robot in an environment with the presence of static obstacles, such as walls, and stochastic, dynamic agents. The requirement for collision avoidance between the robot xᵣ and each agent xₚ and between the robot xᵣ and each static obstacle xₒ can be modeled using distance functions:

$${h}_{p} : {ℝ}^{{n}_{p}} \times {ℝ}^{{n}_{r}} \to {ℝ}^{+}$$

$${h}_{o} : {ℝ}^{{n}_{p}} \times {ℝ}^{{n}_{o}} \to {ℝ}^{+}$$

It is also assumed that hₚ and hₒ are defined in such a way that given a safety threshold ε>0, the sets {(xᵣ, xₚ)|hₚ(xᵣ, xₚ)<ε} and {(xᵣ, xₒ)|hₒ(xᵣ, xₒ)<ε} do not contain disconnected sets of measure zero. The means that the safety problem is well-defined.

### Problem Definition

The problem being solved herein is whether a robot can improve its motion planning performance, e.g., time to reach its goal or energy consumption, if the robot utilizes a model of the agents' awareness of their environment. At the same time, we would like to ensure that safety is not compromised. In other words, we aim to improve the system performance while keeping the risk of collisions bounded by a desired threshold &. Formally, an aim is to solve the following path planning problem:

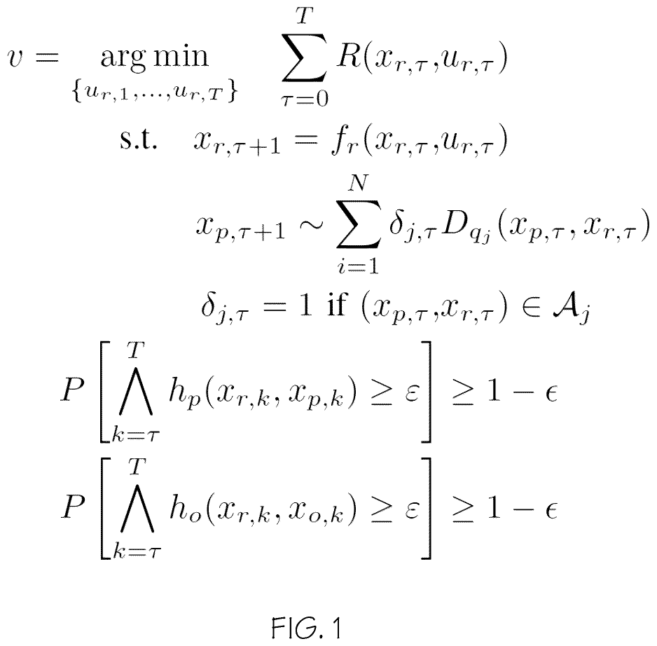

Problem 1. Given the system comprised of x_{r,t+1}=fᵣ(x_{r,t}, u_{r,t}) and x_{p,t+1}~D_{qj} (x_{p,t}, x_{r,t}), a safety threshold ε>0, a risk threshold ϵε[0, 1], and a stage wise cost R: [symbol] × [symbol] → [symbol] , plan a control input trajectory v={u_{r,1}, u_{r,2}, . . . , u_{r,T}} for a horizon T that solves the optimization problem of FIG. 1.

### Preliminaries

Instead of solving Problem 1 exactly, we solve it approximately by imposing hard constraints as penalties in the objective function and using MPPI to find a locally optimal path. In this section, the MPPI algorithm is briefly described as well as the Expansion-Compression UT algorithms that help approximate In. 3 of FIG. 1.

Model Predictive Path Integral Control. MPPI finds a locally optimal solution to an unconstrained optimal control problem by sampling trajectories around a nominal trajectory and assigning weights to the trajectories based on the cost incurred. The final trajectory results from a weighted summation of all the sampled trajectories.

Consider a nonlinear system with state xₜ∈ [symbol] and control input uₜ∈ [symbol] that follows the following discrete-time dynamics

$${x}_{t + 1} = F ( {x}_{t} , {u}_{t} ) .$$

For a time horizon H, consider the state trajectory

$$x = {[ {x}_{t}^{T} , … , {x}_{t + H}^{T} ]}^{T} ,$$

mean control input sequence

$$v = {[ {v}_{t}^{T} , … , {v}_{t + H}^{T} ]}_{T}^{T} , {v}_{T} ∈ \text{?} ,$$

and injected Gaussian noise

$$g = {[ {g}_{t}^{{}_{T}} , … , {g}_{t + H}^{{}_{T}} ]}^{T}$$

where gᵣ~N(0, Σ_{g}). Let the disturbed control input sequence be u=v+g.

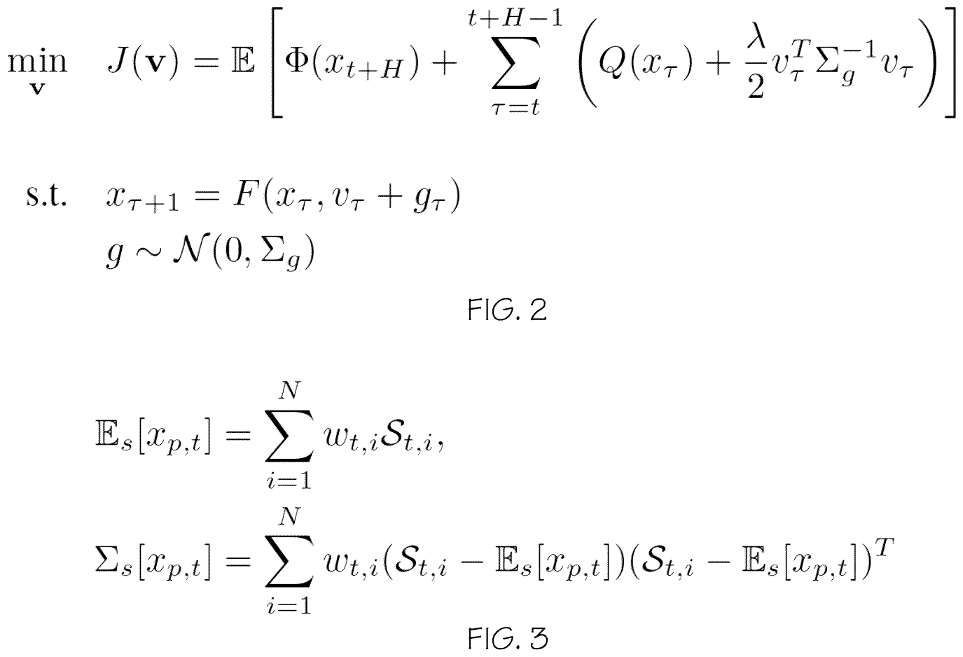

The MPPI algorithm solves the problem of FIG. 2. Below a summary of the MPPI algorithm is provided and refer the reader to G. Williams, P. Drews, B. Goldfain, J. M. Rehg, and E. A. Theodorou, “Information-theoretic model predictive control: Theory and applications to autonomous driving,” IEEE Transactions on Robotics, vol. 34, no. 6, pp. 1603-1622, 2018, which is incorporated herein by reference, for a more theoretical insight into its derivation and optimality properties. MPPI samples M trajectories where M>>1, and each trajectory is affected by a different disturbance sequence c. A superscript ( )^{m} is added to denote quantities corresponding to m^{th} sampled trajectory. The cost Sₘ of each trajectory m∈{1, . . . , M} is evaluated based on line 1 of FIG. 2 as follows

$${S}_{m} = ( {x}_{t + H}^{m} ) {{\sum }_{r = t}}^{t + H - 1} Q ( {m}_{r}^{m} ) + {γ ( {v}_{r}^{m} )}^{T} {\sum }_{g}^{- 1} ( {v}_{r}^{m} + {g}_{r}^{m} )$$

where γ∈[0, λ]. The weight wₘ for m^{th} trajectory is determined as

$${w}_{m} = exp ( - \frac{1}{λ} ( {S}_{m} - β )$$

where β=min_{m∈{1, . . . M}}Sₘ. The optimal control sequence is then computed as

$$v + = {\sum }_{m = 1}^{M} {w}_{m} {u}^{m} / {\sum }_{m = 1}^{M} {w}_{m} .$$

In a reading horizon implementation, control input is chosen as

$${u}_{t} = {v}_{0}^{+}$$

and the mean sequence u for the next iteration is set to be v=v⁺.

Expansion—Compression Unscented Transform: Given an initial state, x_{p,t}, predicting future state distributions under stochastic dynamics such as x_{p,t+1}~D_{qj}(x_{p,t}, x_{r,t}) requires successively evaluating the following integral for all t∈{1, . . . , T}

$$p ( {x}_{p , t + 1} ) = \int p ( {x}_{p , t + 1} \vert {x}_{p , t} : {D}_{{qi}^{}} ) p ( {x}_{p , t} ) d {x}_{p , t} .$$

Several approximate numerical procedures exist to evaluate the equation above as it cannot be evaluated analytically in general. In this disclosure, Expansion-Compression Unscented Transform (ECUT) is used, a method that exploits Unscented Transform (UT) to propagate state distributions across state-dependent uncertain functions.

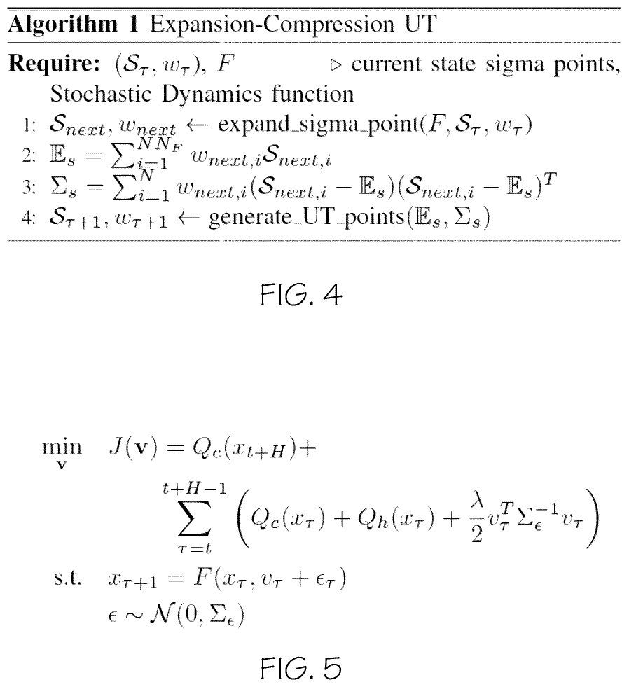

At time t, for x_{p,t}∈ [symbol] , consider a set Sₜ of N particles, or sigma points, S_{t,i}∈ [symbol] , i=1, . . . , N, denoted Sₜ={S_{t,1}, S_{t,2}, . . . , S_{t,N}}, and the set wₜ={w_{t,1}, w_{t,2}, . . . , w_{t,N}} comprising their associated weights w_{t,i}. The sample (or empirical) mean and covariance are computed as shown by FIG. 3.

Given the moments of a distribution of xt, UT provides a principled way of selecting the sigma points Sₜ,wₜ such that their empirical moments are equal to the true moments of a given distribution. For example, the standard UT algorithm presented in S. J. Julier and J. K. Uhlmann, “New extension of the kalman filter to nonlinear systems,” in Signal processing, sensor fusion, and target recognition VI, vol. 3068. Spie, 1997, pp. 182-193, incorporated herein by reference, takes as input the mean and covariance of n dimensional vector and outputs N=2n+1 points and weights. The probability distribution of a function of random variables (state vector in our case) is then obtained by passing sigma points through the function. For example, for xₜ₊₁=F(xₜ), the sigma points Sₜ₊₁ are obtained as

$${S}_{t + 1 , i} = F ( {S}_{t , i} ) .$$

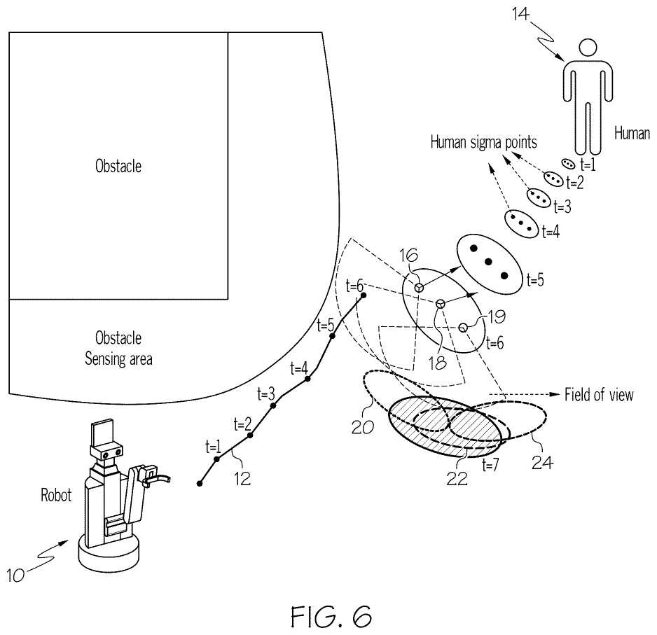

When the function F is stochastic, that is xₜ₊₁~F(xₜ), each sigma point S_{t,i}, maps to a distribution of states defined by F(S_{t,i}). This necessitates increasing the number of sigma points to keep track of distributions. That is, if each S_{t,i} generates N_{F} points (for example, using vanilla UT algorithm based on knowledge of moments F(S_{t,i})), the total number of sigma points for xₜ₊₁ is NNF. However, this implies an increase in the number of sigma points across multiple time steps and therefore this procedure is not scalable. ECUT (see H. Parwana and D. Panagou, “Foresee: Prediction with expansion-compression unscented transform for online policy optimization,” arXiv preprint arXiv:2209.12644, 2022, incorporated herein by reference) provides a scalable way by augmenting the increase in the number of sigma points at each time step, called Expansion operation, by a moment-matching-based Compression operation. The procedure is presented in the Algorithm of FIG. 4 for the sake of completeness. The expand sigma points function in Line 4 generates the NNF sigma points and Lines 5-7 constitute the compression algorithm and generate new N points that have the same mean and covariance as the expanded NNF points. Note that higher-order moments besides the mean and covariance can also be used to generate sigma points.

### Methodology: ECUT-MPPI

MPPI is leveraged to propose an approximate solution to x_{r,t+1}=fᵣ(x_{r,t}, u_{r,t}) that is amenable to real-time implementation. Two algorithmic contributions can be made to applying MPPI for stochastic hybrid systems. First, Expansion-Compression UT is used for state prediction under stochastic dynamics with state-dependent distributions. Second, dynamics are switched based on the sigma particles. This is because although the switching function discussed above is a deterministic function of the robot's and agents' position, the uncertainty in the human's position implies that switching at a given time is also probabilistic. Using sigma points helps capture this stochasticity in switching.

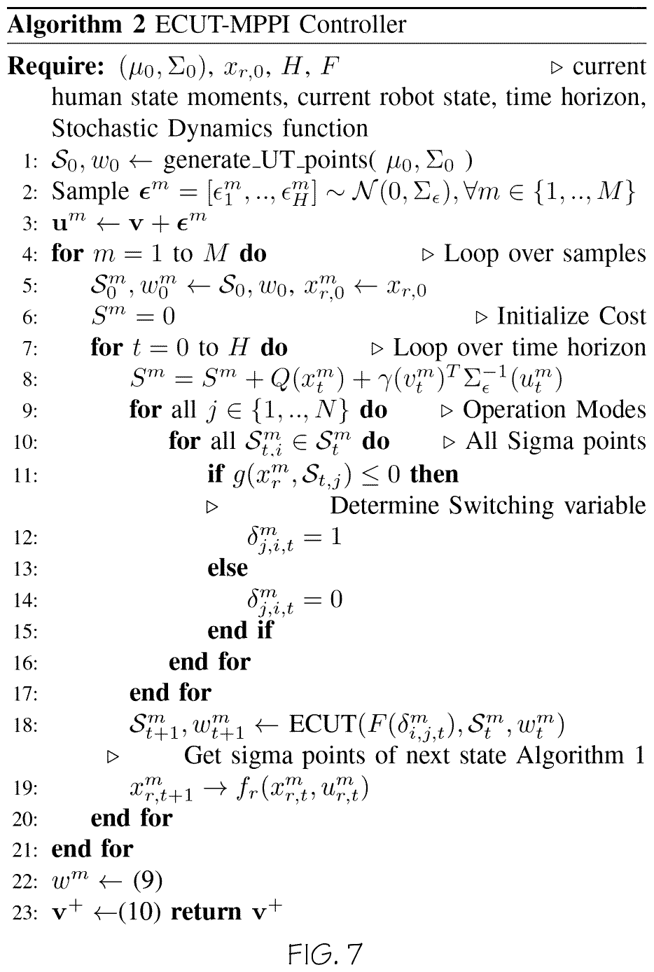

The objective of MPPI is modified to be risk-aware as follows. The stage-wise cost is split into two objectives: Q(x_{r,t})=Qₓ(x_{r,t})+Qₕ(x_{r,t}, x_{p,t}, xₒ), where Q_{c}: [symbol] → [symbol] is for convergence to the desired robot state x_{r,d}, and Qₕ: [symbol] × [symbol] × [symbol] → [symbol] is safety, i.e.,

$${Q}_{c} ( {x}_{r} ) = 𝔼 [ {γ}_{1} {‖ {x}_{r} - {x}_{r , d} ‖}^{2} ] , {Q}_{h} ( {x}_{r} ) = \frac{{γ}_{2}}{{u}_{h , p} - {ασ}_{h , p}} + \frac{{γ}_{3}}{{h}_{obs}} ,$$

where (μ_{h,p}, σ_{h,p}) are the mean and standard deviation of the smallest distance value of distances to all the agents p at time t, h_{obs} is similarly the smallest distance of distances to all the obstacles o, and γ₁, γ₂, γ₃>0 are user-chosen parameters. α is a risk tolerance that can be related to ϵ in FIG. 1, with larger a promoting lower risk tolerance. Essentially, μ_{h,p}−σ_{h,p} represents the lower bound of the central confidence interval of a Gaussian and, for example, ϵ=0.05, α=1.96. The MPPI optimization is thus designed as shown in FIG. 5.

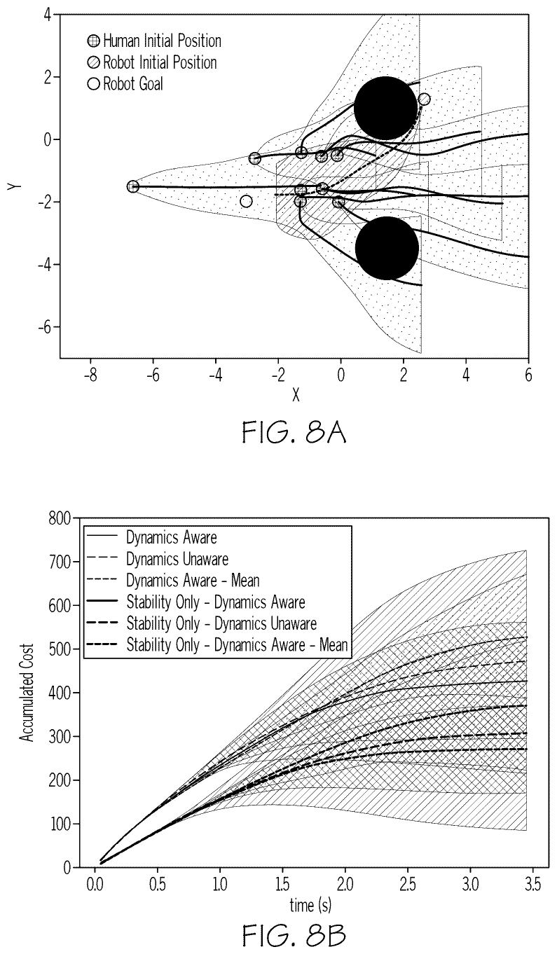

Referring to FIG. 6, a robot's 10 sampled trajectory 12 induces different responses from each of the human's (the non-ego agent in this example) sigma points. The ellipses represent the distribution of predicted human states and the dots inside them represent the sigma points. At t=6, the human 14 perceives the robot 10 for the first time in its field-of-view for 2 out of 3 sigma points. The points 16 and 18 get influenced by robot position at t=6 while the point 19 does not—resulting in three different future ellipses 20, 22 and 24. The compression operation combines the three hollow ellipses 20, 22 and 24 into a single (solid) ellipse to represent human state distribution at t=7. Note that distribution need not be an ellipse and depends on the variant of UT employed.

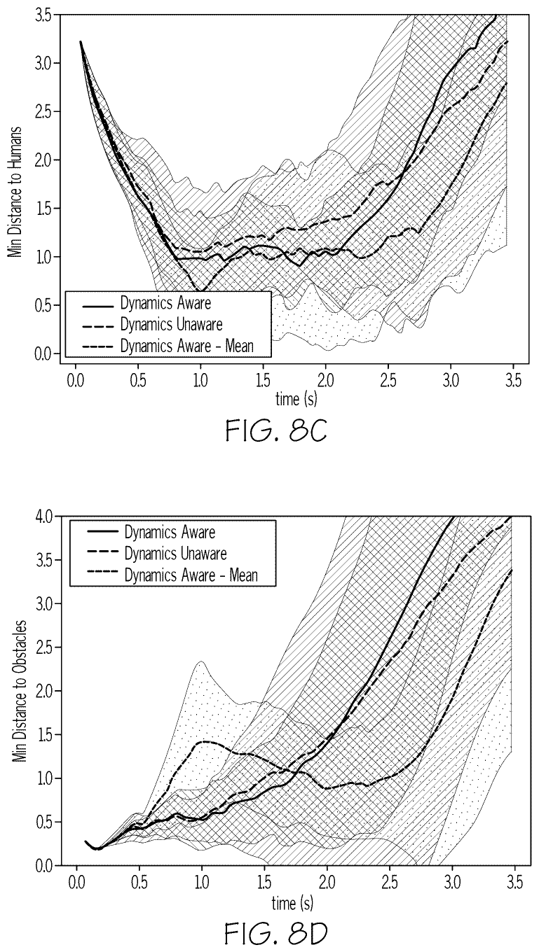

The Algorithm of FIG. 7 shows the proposed framework illustrated in FIG. 5. Let

$${S}_{t}^{m} , {w}_{t}^{m}$$

be the sigma points and weights of the m^{th} sampled trajectory at time t. Further, let

$${δ}_{j , i , t}^{m}$$

be the binary switching variable corresponding to mode j of the sigma point

$${S}_{t , i}^{m}$$

corresponding to the m^{th} sample.

In lines 2 and 3 of FIG. 6, the perturbations are sampled and the control input is computed for each sample. The timestamped robot trajectory, for 1 sample, is illustrated in FIG. 6 with the curve 26. Line 4 loops over the M sampled control perturbed control input sequences. For each control input sequence, line 7 loops over the time horizon and predicts future states. At each time t, line 8 computes the cost incurred at the current state, lines 9-17 determine the operation mode of the human, and line 18 computes the human sigma points at the next time step. When the robot is outside the attention zone, described by the field-of-view in our example, of the human, the human dynamics is unaffected by the robot, shown by the human states for the first five-time steps in FIG. 6. Upon perceiving the robot in its field-of-view, which happens for first time at t=6 in FIG. 6, each sigma point of the human determines its operation mode in lines 12 and 14 and continues propagating sigma points to future.

### Simulation Results

Two case studies are presented for the framework described herein.

### Multi-Agent Navigation

The performance of the framework for short-term planning for a robot navigating amongst 10 non-ego agents and 2 circular obstacles. The scenario is shown in FIG. 7(a). The robot is modeled as a single integrator with the following dynamics

$${\dot{r}}_{x} = {u}_{1} , {\dot{r}}_{y} = {u}_{2}$$

where xᵣ=[rₓr_{y}]^{T} are the X, Y position of the robot and u₁, u₂ are the velocity control inputs. The states of the non-ego agents (other robots or humans for example) are given by xₚ=[pₓ p_{y}]^{T} where pₓ, p_{y} are the position and the control inputs are given by velocities #1, 22. Every non-ego agent has a sensing radius that defines the switching criteria and thus the two operation modes: cooperative (when the robot is inside the sensing region) and uncooperative (otherwise). The non-ego agents use standard infinity going potential field (PF) for collision avoidance. Since PF is a deterministic model and actual non-ego motions in real life may differ from it, the PF is augmented with the following disturbance model.

$$u = PF ( {x}_{r ,} {x}_{p} , {x}_{o} ) + N ( 0 , α tanh ( \frac{β}{‖ \vert {v}_{x} {v}_{y} \vert ‖} ) )$$

where PF(xᵣ, xₚ) is the input from PF, N(0, Σ) is a Gaussian distribution with zero mean and Σ covariance. The covariance is designed to be inversely proportional to the velocity of the non-ego agent, and α, β>0 are user chosen parameters. This model is designed to mimic real-life scenarios where humans and other robots typically change their direction of motion at slower rather than faster speeds.

The algorithm is compared to a baseline based on Risk Aware MPPI (see J. Yin, Z. Zhang, and P. Tsiotras, “Risk-aware model predictive path integral control using conditional value-at-risk,” in 2023 IEEE International Conference on Robotics and Automation (ICRA). IEEE, 2023, pp. 7937-7943 which is incorporated herein by reference. The risk metric proposed in R. Tian, L. Sun, A. Bajcsy, M. Tomizuka, and A. D. Dragan, “Safety assurances for human-robot interaction via confidence-aware game-theoretic human models,” in 2022 International Conference on Robotics and Automation (ICRA). IEEE, 2022, pp. 11 229-11 235 which is incorporated by reference, is chosen. The method of risk evaluation is for every m^{th} sampled control trajectory of the robot, K non-ego agent state trajectories are simulated where for each

$${k}_{m}^{th}$$

trajectory, the non-ego agent motion is predicted by randomly sampling from its stochastic dynamics function resulting in a total of MK sampled trajectories. The risk for mth robot control sample is thus evaluated using the corresponding K human trajectories. Note that treating each sigma-point as an independent sample, the method equivalently samples a total of MN trajectories where N=2n+1 for vanilla UT. In practice, N<<M for similar accuracy and therefore the objective here is to compare the achieved risk for similar computational speed, see D. Ebeigbe, T. Berry, M. M. Norton, A. J. Whalen, D. Simon, T. Sauer, and S. J. Schiff, “A generalized unscented transformation for probability distributions,” ArXiv, 2021 and L. Angrisani, M. D′Apuzzo, and R. S. L. Moriello, “The unscented transform: a powerful tool for measurement uncertainty evaluation,” in Proceedings of the 2005 IEEE International Workshop on Advanced Methods for Uncertainty Estimation in Measurement, 2005. IEEE, 2005, pp. 27-32, which are incorporated herein by reference.

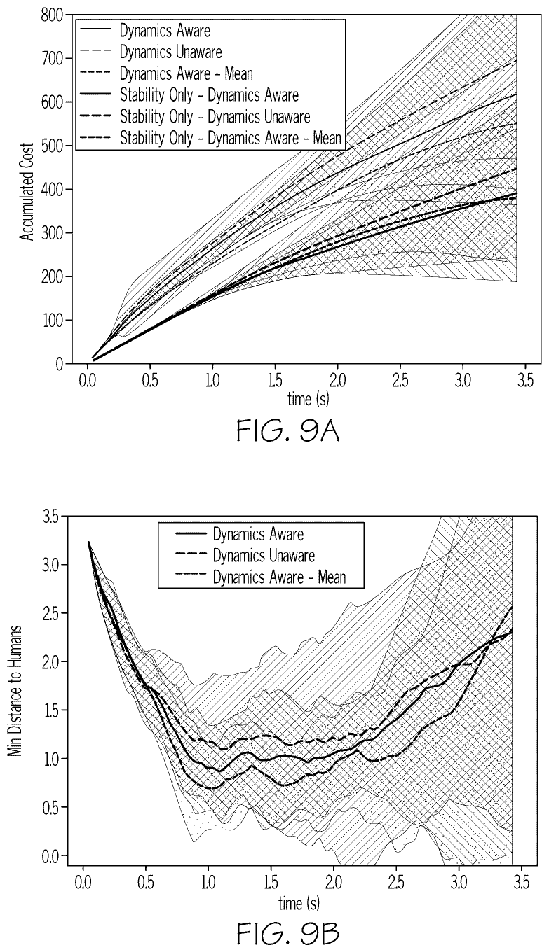

The MPPI code is written in JAX and the simulations are performed on a laptop running Ubuntu 22.04 with 19-13905H CPU. Our code performs in real-time on CPU with up to M=500 samples and on GPU with up to M=20000 samples. The prediction horizon is H=40 with a time step of Δt=0.05 s. We also choose Σϵ=4.0 in FIG. 2, α=4.0/Δt, β=1.0. Three cases are compares: hybrid-dynamics aware, hybrid dynamics unaware, and mean-based prediction for M=500 on CPU. In the aware case, the robot incorporates a non-ego agent's hybrid motion model in its prediction, whereas in the unaware case, it assumes that non-ego agents are always uncooperative. In the mean-based prediction, the robot performs switching for non-ego agent dynamics based only on their mean positions. It is shown that the aware case leads to lower costs while still maintaining safety requirements whereas the mean-based prediction leads to worse results compared to the dynamics aware case. The humans are moved according to H. Parwana and D. Panagou, “Foresee: Prediction with expansion-compression unscented transform for online policy optimization,” arXiv preprint arXiv:2209.12644, 2022 which is incorporated herein by reference and do a Monte Carlo evaluation of our framework by running it 50 times. FIG. 8B shows the cumulative cost as a function of time and FIGS. 8C and 8D show the nearest distance to any non-ego agent and obstacle at a given time. Note that non-ego agents move independently in a decentralized fashion. The dynamics-aware MPPI that predicts non-ego agents' motion based on the knowledge of decentralized dynamics incurs lower costs and observes no constraint violation up to a 95% confidence interval of MC simulations. The mean-based prediction and dynamics-unaware case initially perform well but the performance degrades with time—the cost increases and constraints are violated (distance to humans is 0 and to obstacles boundary less than 0).

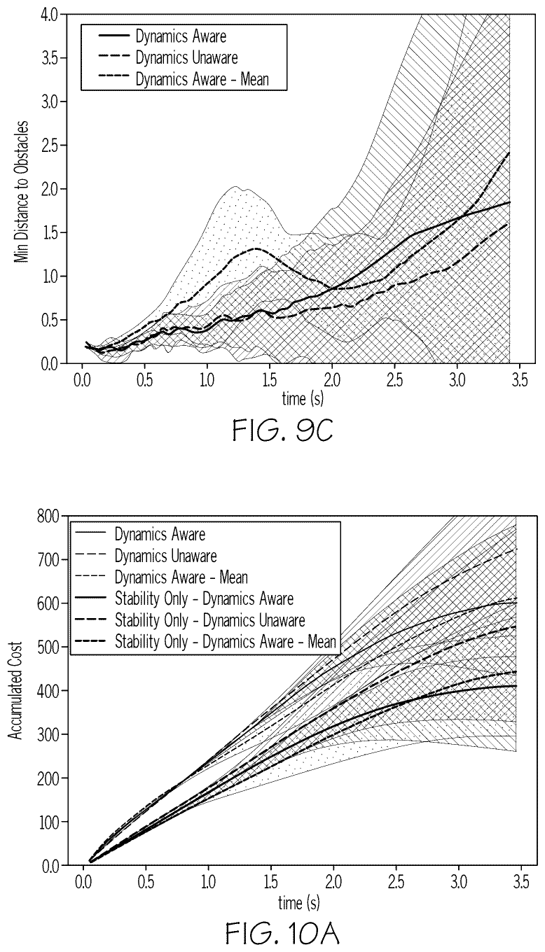

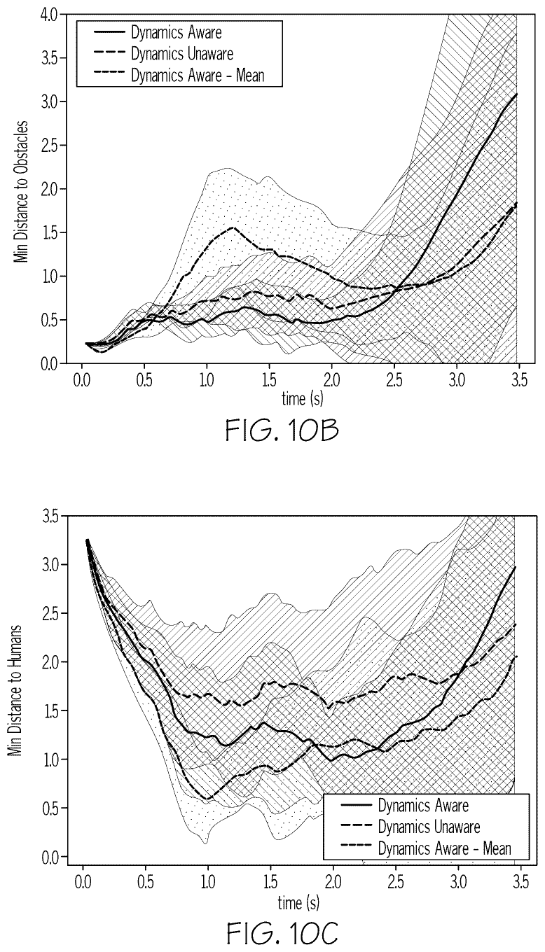

For RA-MPPI inspired method, it is found that choosing K=20 leads to a similar computation time per MPPI iteration as the method, and show its results in FIGS. 9A-9C. It is found that RA-MPPI inspired method fails to satisfy safety with the desired probabilistic bounds. For K>20, the RA-MPPI inspired method takes longer than our method but to compare purely in terms of performance, it is shown results for K=100 (which runs 10 times slower than our algorithm) in FIGS. 10A-10C. Note that K=200 is much closer (although still has violations) suggesting that the accuracy of UT-based prediction in the method described herein is equivalent to predicting using large MC samples.

It should be clarified that the implementation speed depends significantly on the programming language and hardware acceleration. The claims on the number of particles required for similar performance between the inspired method and the proposed method are only representative of the behavior we observed in the implementation. Also, note that while the proposed method works better in the described case study, Monte Carlo is more accurate than existing UT algorithms when a large number of particles are chosen. Monte Carlo is also better at representing multi-modal distributions than existing UT algorithms. Nevertheless, the method is suitable for real-time implementation where hardware limitations impose constraints on the number of particles. Moreover, the algorithms can incorporate any improvements in UT algorithms. Finally, note that each non-ego agent is 2-dimensional, and therefore the total size of the state space is 22 and the computation time is expected to increase drastically despite software optimizations.

### AWS Hospital Gazebo Experiments

The framework is evaluated on a gazebo simulator moving the robot in AWS Hospital environment that was developed in our previous work [35]. The JAX code is run on an NVIDIA RTX 4060 Laptop GPU with 10,000 samples.

The humans are modeled using a social force model K. Minami, K. Hayashi, and J. Miura, “Development of the pedestrian awareness model for mobile robots,” in 32nd IEEE International Conference on Robot and Human Interactive Communication (RO-MAN). IEEE, 2023, pp. 1295-1301 incorporated herein by reference standard distance-based potential field (PF) to simulate more realistic motions than the standard potential field. The algorithm though uses the model in H. Parwana and D. Panagou, “Foresee: Prediction with expansion-compression unscented transform for online policy optimization,” arXiv preprint arXiv:2209.12644, 2022 to predict humans' trajectories as SFM uses a 4-dimensional state per human which severely constrains the number of samples used by MPPI. The trajectory prediction is limited to the nearest 4 humans rather than all the humans. This results in the algorithm being run at 20 Hz.

The robot follows the unicycle model given by following equations r′ₓ=u₁ cos r_{θ}, r′_{y}=u₁ sin r_{θ}, r′_{θ}=u₂ where rₓ, r_{y}, r_{θ} are the position and heading angle of the robot and u₁, u₂ are the linear and angular velocity control input. The ROS2 navigation stack's planner is used to plan a global path to the goal at the beginning and the proposed MPPI framework as a receding horizon controller to track the global path's waypoints.

A variant of MPPI using Unscented Transform for stochastic hybrid dynamical systems is proposed herein. The future state prediction scheme can map the uncertainty of states to the uncertainty in switching. The framework can be implemented in real-time on both CPU and GPU subject to limits on the number of samples.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A computer-implemented method of path planning for a mobile robot in a dynamic environment, the method comprising:
modeling awareness of an agent for the path planning;
using an Expansion-Compression (EC) Unscented Transform (UT) Model Predictive Path Integral (MPPI) controller comprising an ECUT algorithm and MPPI algorithm for the path planning by sampling possible trajectories of the mobile robot around a nominal trajectory and assigning weights to the trajectories based on a cost incurred; and
determining a final trajectory of the mobile robot from a weighted summation of all the sampled trajectories.

2. The method of claim 1 further comprising switching dynamics based on sigma points.

3. The method of claim 2 comprising the ECUT-MPPI controller selecting sigma points such that empirical moments are equal to true moments of a given distribution.

4. The method of claim 1, wherein the MPPI algorithm is configured to be risk-aware.

5. The method of claim 1 comprising using the ECUT algorithm for state prediction under stochastic dynamics with state-dependent distributions.

6. The method of claim 1 further comprising evaluating performance of the ECUT-MPPI controller using a simulation.

7. The method of claim 1 further comprising using a safety threshold for collision avoidance with the agent in the dynamic environment.

8. A computer-implemented method of path planning for a mobile robot in a dynamic environment, the method comprising:
using an Expansion-Compression (EC) Unscented Transform (UT) Model Predictive Path Integral (MPPI) controller comprising an ECUT algorithm and MPPI algorithm for the path planning; and
determining a final trajectory of the mobile robot from a weighted summation of sampled trajectories.

9. The method of claim 8 further comprising switching dynamics based on sigma points.

10. The method of claim 9 comprising the ECUT-MPPI controller selecting sigma points such that empirical moments are equal to true moments of a given distribution.

11. The method of claim 8, wherein the MPPI algorithm is configured to be risk-aware.

12. The method of claim 8 comprising using the ECUT algorithm for state prediction under stochastic dynamics with state-dependent distributions.

13. The method of claim 8 further comprising evaluating performance of the ECUT-MPPI controller using a simulation.

14. The method of claim 8 further comprising using a safety threshold for collision avoidance with the agent in the dynamic environment.

15. A system configured to plan a path for a mobile robot in a dynamic environment, the system comprising:
a computer comprising logic saved in memory that is configured to:
model awareness of an agent for the path planning;
use an Expansion-Compression (EC) Unscented Transform (UT) Model Predictive Path Integral (MPPI) controller comprising an ECUT algorithm and MPPI algorithm for the path planning by sampling possible trajectories of the mobile robot around a nominal trajectory and assign weights to the trajectories based on a cost incurred; and
determine a final trajectory of the mobile robot from a weighted summation of all the sampled trajectories.

16. The system of claim 15, wherein the computer, based on the logic, is configured to switch dynamics based on sigma points.

17. The system of claim 16, wherein the computer, based on the logic, is configured to select sigma points such that empirical moments are equal to true moments of a given distribution.

18. The system of claim 15, wherein the MPPI algorithm is configured to be risk-aware.

19. The system of claim 15, wherein the computer is configured to evaluate performance of the ECUT-MPPI controller using a simulation.

20. The system of claim 15, wherein the computer, based on the logic, is configured to use a safety threshold for collision avoidance with the agent in the dynamic environment.
